(19) United States
(12) Patent Application Publication
(10) Pub. No.: US 2019/0215503 A1
(43) Pub. Date: Jul. 11, 2019

(54) 360-DEGREE VIDEO POST-ROLL

(71) Applicant: Microsoft Technology Licensing, LLC, Redmond, WA (US)

(72) Inventors: Aaron MONSON, Issaquah, WA (US); Jae Chul BAE, Redmond, WA (US); Emmanuel BERTRAND, Seattle, WA (US); Eliezer Menachem PAYZER, Redmond, WA (US); Pedro Javier RAMIREZ, Seattle, WA (US); Daniel Thomas CORRIGAN, Issaquah, WA (US); Colin Randall MOLL, Bothell, WA (US)

(73) Assignee: Microsoft Technology Licensing, LLC, Redmond, WA (US)

(21) Appl. No.: 15/863,793

(22) Filed: Jan. 5, 2018

(51) Int. Cl. H04N 13/00; G06F 3/0481; G06F 3/0487; G06F 3/01; G06F 3/0482

(52) U.S. Cl. CPC H04N 13/0055; G06F 3/04817; H04N 13/044; G06F 3/0482; G06F 3/0487; G06F 3/04812; G06F 3/013; H04N 13/0484

(57) ABSTRACT

According to one embodiment of the present disclosure, a head-mounted display device is provided, including a display, one or more input devices, and a processor. The processor may be configured to display a first 360-degree video on the display in a three-dimensional playback environment. The processor may be further configured to display a post-roll on the display when the first 360-degree video ends, wherein the post-roll is displayed in the three-dimensional playback environment and includes one or more interactable icons. The processor may be further configured to detect a selection of an interactable icon of the one or more interactable icons via the one or more input devices. The processor may be further configured to, in response to detecting the selection, perform a video environment navigation action.

### BACKGROUND

360-degree video offers immersive video experiences for virtual reality (VR) system users. However, due to the increased immersion provided by the 360-degree video format, transitions between virtual environments that may occur when using a 360-degree video application program may be jarring for users. Individual 360-degree videos are often short, and users may often watch several 360-degree videos consecutively. In existing 360-degree video application programs, the user returns to a home virtual environment at the end of each video. The number of transitions in a single viewing session may therefore be large.

### SUMMARY

According to one aspect of the present disclosure, a head-mounted display device is provided, comprising a display, one or more input devices, and a processor. The processor may be configured to display a first 360-degree video on the display in a three-dimensional playback environment. The processor may be further configured to display a post-roll on the display when the first 360-degree video ends, wherein the post-roll is displayed in the three-dimensional playback environment and includes one or more interactable icons. The processor may be further configured to detect a selection of an interactable icon of the one or more interactable icons via the one or more input devices. The processor may be further configured to, in response to detecting the selection, perform a video environment navigation action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example head-mounted display device, according to one embodiment of the present disclosure.

FIG. 2 depicts an example 360-degree video displayed in a three-dimensional playback environment, according to the embodiment of FIG. 1.

FIG. 3 shows an example three-dimensional playback environment including a post-roll, according to the embodiment of FIG. 1.

FIG. 4 shows examples of launching an application program, according to the embodiment of FIG. 1.

FIG. 5 shows an example of a first preview image, according to the embodiment of FIG. 1.

FIG. 6 shows a post-roll that is relocated in response to a position sensor input, according to the embodiment of FIG. 1.

FIG. 7 shows a head-mounted display device configured to receive one or more icon parameters from a server computing device, according to the embodiment of FIG. 1.

FIG. 8A shows a flowchart of a method for use with a head-mounted computing device, according to one embodiment of the present disclosure.

FIG. 8B shows additional steps of the method that may optionally be performed, including receiving a position sensor input.

FIG. 8C shows additional steps of the method that may optionally be performed, including tracking a gaze direction of a user.

FIG. 8D shows additional steps of the method that may optionally be performed, including receiving one or more icon parameters.

FIG. 9 shows a schematic representation of an example computing system, according to one embodiment of the present disclosure.

### DETAILED DESCRIPTION

In view of the problem discussed above, the inventors have developed a system for reducing the number of virtual environment transitions that occur during a 360-degree video viewing session. This system is disclosed in the example embodiments herein.

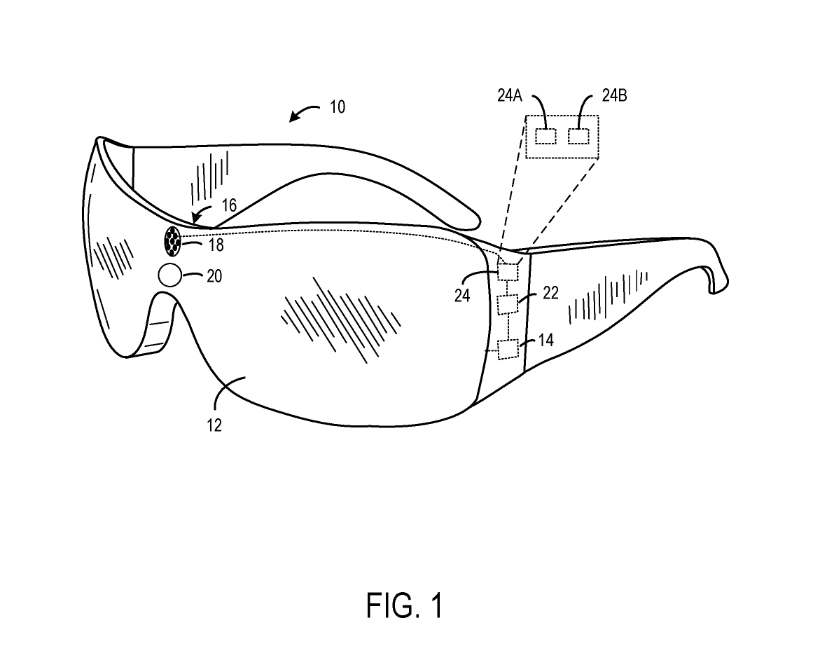

FIG. 1 illustrates an example head-mounted display device 10. The illustrated head-mounted display device 10 takes the form of wearable glasses or goggles, but it will be appreciated that other forms are possible. The head-mounted display device 10 may include a display 12. In some embodiments, the head-mounted display device 10 may be configured in an augmented reality configuration to present an augmented reality environment, and thus the display 12 may be an at least partially see-through stereoscopic display configured to visually augment an appearance of a physical environment being viewed by the user through the display. In some examples, the display 12 may include one or more regions that are transparent (e.g. optically clear) and may include one or more regions that are opaque or semi-transparent. In other examples, the display 12 may be transparent (e.g. optically clear) across an entire usable display surface of the display 12. Alternatively, the head-mounted display device 10 may be configured in a virtual reality configuration to present a full virtual reality environment, and thus the display 12 may be a non-see-though stereoscopic display. The head-mounted display device 10 may be configured to display virtual three-dimensional environments to the user via the non-see-through stereoscopic display. The head-mounted display device 10 may be configured to display a virtual representation such as a three-dimensional graphical rendering of the physical environment in front of the user that may include additional virtual objects, such as a cursor, or may be configured to display camera-captured images of the physical environment along with additional virtual objects including the cursor overlaid on the camera-captured images.

For example, the head-mounted display device 10 may include an image production system 14 that is configured to display virtual objects to the user with the display 12. In the augmented reality configuration with an at least partially see-through display, the virtual objects are visually superimposed onto the physical environment that is visible through the display 12 so as to be perceived at various depths and locations. In the virtual reality configuration, the image production system 14 may be configured to display virtual objects to the user with the non-see-through stereoscopic display, such that the virtual objects are perceived to be at various depths and locations relative to one another. In one embodiment, the head-mounted display device 10 may use stereoscopy to visually place a virtual object at a desired depth by displaying separate images of the virtual object to both of the user's eyes. Using this stereoscopy technique, the head-mounted display device 10 may control the displayed images of the virtual objects, such that the user will perceive that the virtual objects exist at a desired depth and location in the viewed physical environment. In one example, the virtual object may be a cursor that is displayed to the user, such that the cursor appears to the user to be located at a desired location in the virtual three-dimensional environment. In the augmented reality configuration, the virtual object may be a holographic cursor that is displayed to the user, such that the holographic cursor appears to the user to be located at a desired location in the real world physical environment.

The head-mounted display device 10 may include one or more input devices with which the user may input information. The user input devices may include one or more optical sensors and one or more position sensors, which are discussed in further detail below. Additionally or alternatively, the user input devices may include one or more buttons, control sticks, microphones, touch-sensitive input devices, or other types of input devices.

The head-mounted display device 10 includes an optical sensor system 16 that may include one or more optical sensors. In one example, the optical sensor system 16 includes an outward-facing optical sensor 18 that may be configured to detect the real-world background from a similar vantage point (e.g., line of sight) as observed by the user through the display 12 in an augmented reality configuration. The optical sensor system 16 may additionally include an inward-facing optical sensor 20 that may be configured to detect a gaze direction of the user's eye. It will be appreciated that the outward facing optical sensor 18 may include one or more component sensors, including an RGB camera and a depth camera. The RGB camera may be a high definition camera or have another resolution. The depth camera may be configured to project non-visible light and capture reflections of the projected light, and based thereon, generate an image comprised of measured depth data for each pixel in the image. This depth data may be combined with color information from the image captured by the RGB camera, into a single image representation including both color data and depth data, if desired. In a virtual reality configuration, the color and depth data captured by the optical sensor system 16 may be used to perform surface reconstruction and generate a virtual model of the real-world background that may be displayed to the user via the display 12. Alternatively, the image data captured by the optical sensor system 16 may be directly presented as image data to the user on the display 12.

The head-mounted display device 10 may further include a position sensor system 22 that may include one or more position sensors such as accelerometer(s), gyroscope(s), magnetometer(s), global positioning system(s), multilateration tracker(s), and/or other sensors that output position sensor information useable as a position, orientation, and/or movement of the relevant sensor.

Optical sensor information received from the optical sensor system 16 and/or position sensor information received from position sensor system 22 may be used to assess a position and orientation of the vantage point of head-mounted display device 10 relative to other environmental objects. In some embodiments, the position and orientation of the vantage point may be characterized with six degrees of freedom (e.g., world-space X, Y, Z, pitch, roll, yaw). The vantage point may be characterized globally or independent of the real-world background. The position and/or orientation may be determined with an on-board computing system (e.g., on-board computing system 24) and/or an off-board computing system, which may at least one processor 24A and/or at least one memory unit 24B.

Furthermore, the optical sensor information and the position sensor information may be used by a computing system to perform analysis of the real-world background, such as depth analysis, surface reconstruction, environmental color and lighting analysis, or other suitable operations. In particular, the optical and positional sensor information may be used to create a virtual model of the real-world background. In some embodiments, the position and orientation of the vantage point may be characterized relative to this virtual space. Moreover, the virtual model may be used to determine positions of virtual objects in the virtual space and add additional virtual objects to be displayed to the user at a desired depth and location within the virtual world.

Additionally, the optical sensor information received from the optical sensor system 16 may be used to identify and track objects in the field of view of optical sensor system 16. For example, depth data captured by optical sensor system 16 may be used to identify and track motion of a user's hand. The tracked motion may include movement of the user's hand in three-dimensional space, and may be characterized with six degrees of freedom (e.g., world-space X, Y, Z, pitch, roll, yaw). The tracked motion may also be used to identify and track a hand gesture made by the user's hand. For example, one identifiable hand gesture may be moving a forefinger upwards or downwards. It will be appreciated that other methods may be used to identify and track motion of the user's hand. For example, optical tags may be placed at known locations on the user's hand or a glove worn by the user, and the optical tags may be tracked through the image data captured by optical sensor system 16.

It will be appreciated that the following examples and methods may be applied to both a virtual reality and an augmented reality configuration of the head-mounted display device 10. In a virtual reality configuration, the display 12 of the head-mounted display device 10 is a non-see-through display, and the three-dimensional environment is a virtual environment displayed to the user. The virtual environment may be a virtual model generated based on image data captured of the real-world background by optical sensor system 16 of the head-mounted display device 10. Additionally, a cursor having a modifiable visual appearance is also displayed to the user on the display 12 as having a virtual location within the three-dimensional environment. In an augmented reality configuration, the cursor is a holographic cursor that is displayed on an at least partially see-through display, such that the cursor appears to be superimposed onto the physical environment being viewed by the user.

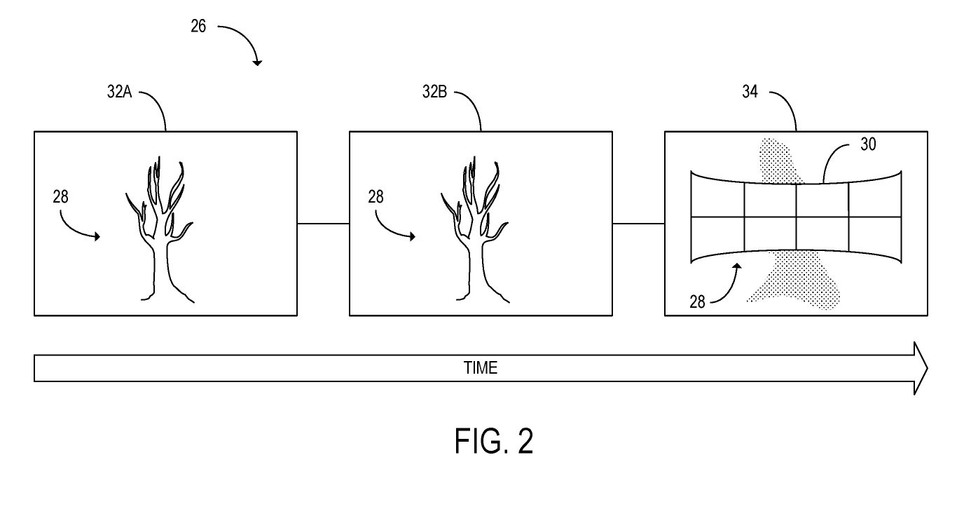

When the head-mounted display device 10 is in a virtual reality configuration, processor 24A of the head-mounted display device 10 may be configured to display a 360-degree video on the display 12. FIG. 2 depicts a first 360-degree video 26 displayed in a three-dimensional playback environment 28. The last three frames 32A, 32B, and 34 of the 360-degree video 26 are shown in chronological order from left to right. When the first 360-degree video 26 ends, the processor 24A may be configured to display a post-roll 30 on the display 12. In some embodiments, as shown in FIG. 2, the post-roll 30 may be displayed over at least the last frame 34 of the first 360-degree video 26. In such embodiments, the last frame 34 of the first 360-degree video 26 may have a visual effect applied thereto, such as blurring, when the post-roll 30 is displayed. In other embodiments, the post-roll 30 may be displayed over more than one frame of the first 360-degree video 26, or following the last frame 34 of the 360-degree video 26. As an alternative to blurring, the frame may be displayed using other visual effects that provide a visual cue to the user that the end of the video has been reached, and which completely or partially obscures or deemphasizes the content of the last frame 34. Further, while the last frame is described as having the visual effect applied thereto, it will be appreciated that a group of frames at the end of the first 360-degree video may have the visual effect so applied. Further, although the visual effect is described as being applied when the post-roll 30 is displayed, it will be appreciated that the visual effect may be applied prior to the post-roll 30 being displayed as while as during its display. The transition to this visual effect may be sudden or gradual, depending on preference.

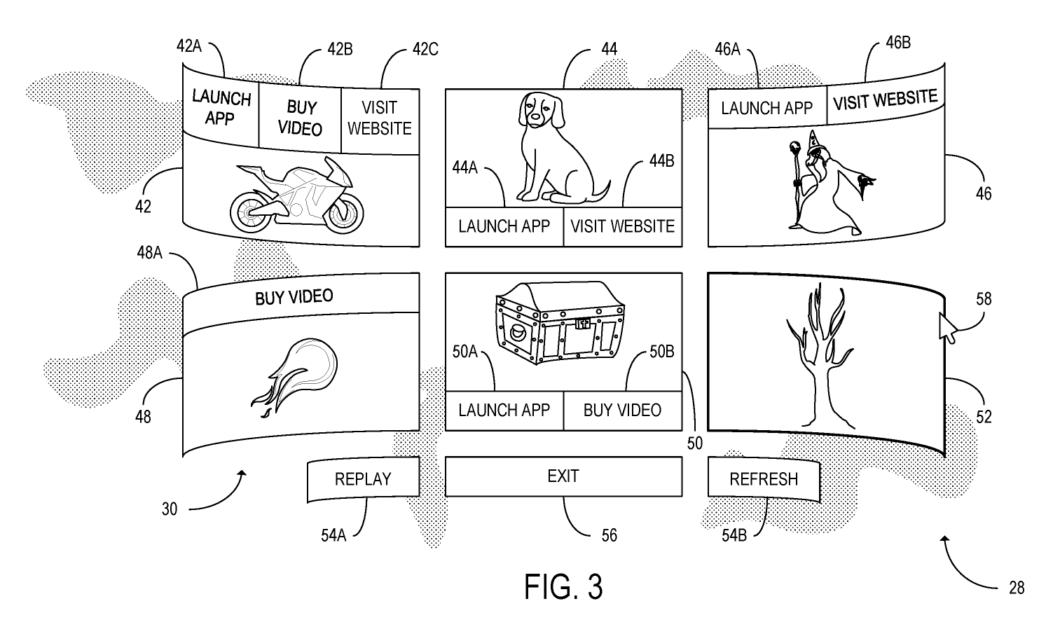

The three-dimensional playback environment 28 including the post-roll 30 is shown in greater detail in FIG. 3, according to one example embodiment. The post-roll 30 may include one or more interactable icons that may be selected by the user. The processor 24A may be configured to detect a selection of an interactable icon of the one or more interactable icons via the one or more input devices of the head-mounted display device 10. For example, in embodiments where the one or more input devices include a camera configured to track a gaze direction of the user, such as the inward-facing optical sensor 20 shown in FIG. 1, the selection of the interactable icon may be detected based at least in part on the gaze direction. Additionally or alternatively, the interactable icon may be selected by other forms of input, such as a gesture input detected by the outward-facing optical sensor 18. In response to detecting the selection of the interactable icon, the processor 24A may be configured to perform a video environment navigation action. Example video environment navigation actions are discussing in further detail below.

In the example of FIG. 3, the post-roll includes interactable icons displayed as previews 42, 44, 46, 48, 50, and 52 of additional 360-degree videos. The previews may be displayed as videos or still images. In addition, each preview may be displayed with one or more associated interactable icons in the form of buttons. The preview 42 of the first additional 360-degree video is displayed with a “Launch App” button 42A, a “Buy Video” button 42B, a “Visit Website” button 42C in an upper portion of the preview. The preview 44 of the second additional 360-degree video is displayed with a “Launch App” button 44A and a “Visit Website” button 44B in a lower portion of the preview. The preview 46 of the third additional 360-degree video is displayed with a “Launch App” button 46A and a “Visit Website” button 46B in an upper portion of the preview. The preview 48 of the fourth additional 360-degree video is displayed with only a “Buy Video” button 48A in an upper portion of the preview. The preview 50 of the fifth additional 360-degree video is displayed with a “Launch App” button 50A and a “Buy Video” button 50B in a lower portion of the preview. The preview 52 of the sixth additional 360-degree video is displayed without associated interactable icons.

In response to the selection of an interactable icon, if the interactable icon is a preview image of an additional 360-degree video, the video environment navigation action may include displaying the additional 360-degree video on the display 12. The additional 360-degree video may be displayed without returning to a three-dimensional virtual home environment or menu screen. Instead, the processor 24A may be configured to continue to display the three-dimensional playback environment 28 when the additional 360-degree video is displayed. The number of transitions between three-dimensional virtual environments that occur in one session of 360-degree video viewing may thereby be reduced.

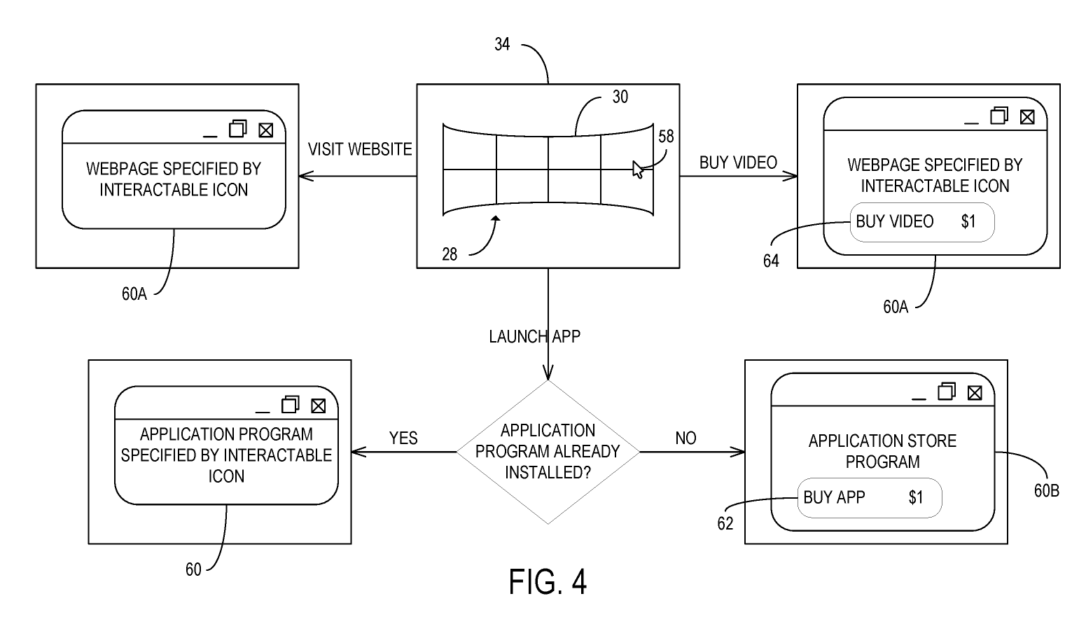

The video environment navigation action performed in response to the selection of an interactable icon may include launching an application program. Examples of launching an application program in response to the selection of an interactable icon are shown in FIG. 4. The application program 60 may be a web browser 60A, and launching the web browser 60A may include navigating to a webpage specified by the interactable icon. For example, the processor 24A may be configured to launch the web browser 60A in response to selection of the “Visit Website” button 42C shown in FIG. 3. The interactable icon may indicate a web address to which the processor 24A is configured to navigate when the web browser 60A is launched.

In some embodiments, the processor 24A may determine whether the application program 60 specified by the selected interactable icon is installed on the one or more memory units 24B of the head-mounted display device 10. If the application program 60 indicated by the interactable icon is already installed on the one or more memory units 24B, the processor 24A may be configured to launch the application program 60. If the application program is not installed, the processor 24A may be configured to launch an application store program 60B, which may include an option 62 to buy the application program 60. Alternatively, the processor 24A may display an error message or perform some other video environment navigation action. In the example of FIG. 3, the processor 24A may launch the application store program 60B in response to selection of the “Launch App” button 42A.

In some embodiments, the application program 60 may include an option 64 to purchase at least one of the first 360-degree video 26 and another 360-degree video. For example, the processor 24A may launch the web browser 60A and navigate to a webpage that includes such an option 64 in response to selection of the “Buy Video” button 42B.

Returning to FIG. 3, the three-dimensional playback environment 28 also includes a “Replay” interactable icon 54A, a “Refresh” interactable icon 54B, and an “Exit” interactable icon 56. When the “Replay” interactable icon 54A is selected, the video environment navigation action performed by the processor 24A may include replaying the first 360-degree video 26.

When the “Refresh” interactable icon 54B is selected, the video environment navigation action may include refreshing the post-roll 30. When the post-roll 30 is refreshed, at least one new interactable icon may be displayed in the three-dimensional playback environment 28. In addition, at least one interactable icon may be removed from the three-dimensional playback environment 28. For example, the at least one new interactable icon may be a preview for a 360-degree video not displayed before the “Refresh” interactable icon 54B is selected, and may replace one of the previews 42, 44, 46, 48, 50, and 52. A user who does not desire to watch any of the 360-degree videos previewed in the post-roll 30 may therefore refresh the post-roll 30 in order to view previews of other 360-degree videos. In some embodiments, the at least one new interactable icon may be determined based on one or more filtering criteria. For example, the one or more filtering criteria may be entered by the user as one or more search terms, or may be determined based on one or more 360-degree videos previously watched by the user.

When the “Exit” interactable icon 56 is selected, the video environment navigation action may include exiting the three-dimensional playback environment 28. Subsequently to exiting the three-dimensional playback environment 28, the processor 24A may be further configured to display a three-dimensional virtual home environment or menu.

In some embodiments, one or more of the “Replay” interactable icon 54A, the “Refresh” interactable icon 54B, and the “Exit” interactable icon 56 may be displayed at a depth different from the depth at which the previews 42, 44, 46, 48, 50, and 52 of the additional 360-degree videos are displayed. Thus, the “Replay” interactable icon 54A, the “Refresh” interactable icon 54B, and the “Exit” interactable icon 56 may be made more easily distinguishable from the other interactable icons included in the post-roll 30.

In the embodiment of FIG. 3, a cursor 58 is displayed in the three-dimensional playback environment 28. In embodiments in which the one or more input devices include a camera configured to track a gaze direction of the user, the processor 24A may be configured to display the cursor 58 at a location in the three-dimensional playback environment 28 based at least in part on the gaze direction of the user. For example, the cursor 58 may be displayed at a location at which the user is gazing. In addition, the processor 24A may be further configured to modify an appearance of the interactable icon overlapped by the cursor 58. In the example embodiment of FIG. 3, the frame of the preview 52 overlapped by the cursor 58 is displayed in bold. The appearance of the preview 52 overlapped by the cursor 58 may additionally or alternatively be modified in other ways. For example, the color, size, shape, brightness, or depth of all or part of the preview 52 may be modified.

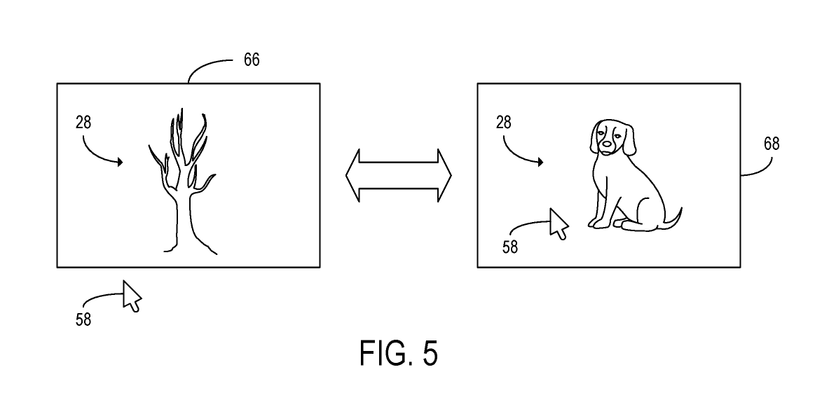

FIG. 5 shows an example embodiment in which the interactable icon is a first preview image 66 of another 360-degree video. The processor 24A may be configured to display a second preview image 68 when the cursor 58 overlaps the interactable icon. If the cursor 58 ceases to overlap the interactable icon, the processor 24A may be configured to return to displaying the first preview image 66.

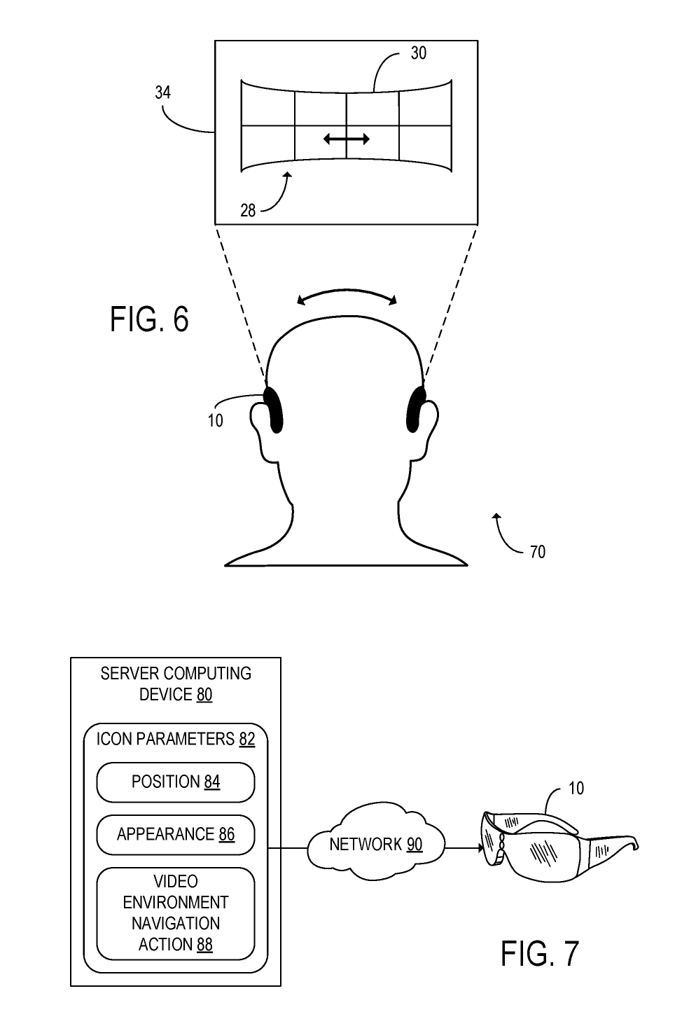

In embodiments in which the head-mounted display device 10 includes a position sensor system 22, the processor 24A may be further configured to receive a position sensor input that indicates movement of the head-mounted display device 10 in a physical environment 70, as shown in FIG. 6. In response to receiving the position sensor input, the processor 24A may be further configured to relocate the post-roll 30 within the three-dimensional playback environment 28. For example, the post-roll 30 may be head-pose-locked such that in response to a head movement, the post-roll 30 moves by a corresponding amount in the same direction as the head movement. The post-roll 30 may thus be kept in the user's view as the user's head moves. Alternatively, the processor 24A may be configured to scroll vertically and/or horizontally through the post-roll 30 in response to a head movement. In other embodiments, the post-roll 30 may be displayed at a fixed location within the three-dimensional playback environment 28.

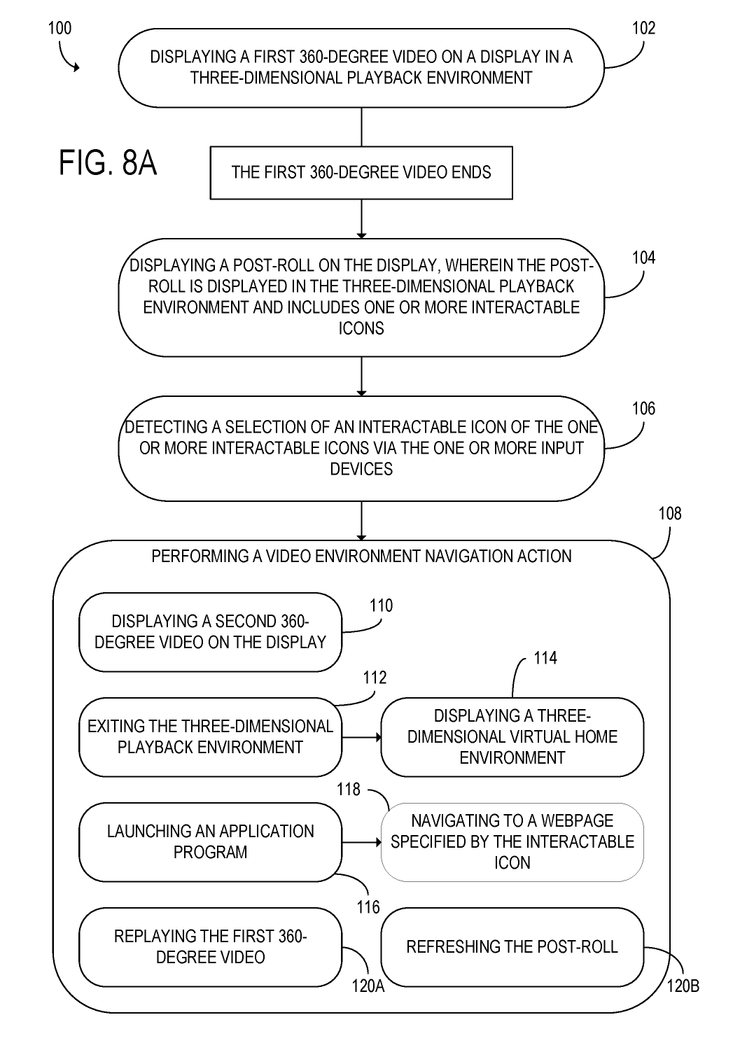

In some embodiments, characteristics of an interactable icon included in the post-roll 30 may be specified by a content provider, as shown in FIG. 7. The processor 24A may be configured to receive one or more icon parameters 82 of the interactable icon from a server computing device 80. The one or more icon parameters 82 may be conveyed to the head-mounted display device 10 over a network 90, which may be a wireless telephone network or a wired or wireless local- or wide-area network. The server computing device 80 may convey the icon parameters 82 to an on-board computing system or off-board computing system of the head-mounted display device 10.

The one or more icon parameters 82 may indicate at least one of a position 84 and an appearance 86 of the interactable icon. The appearance 86 of the interactable icon may include, for example, a depth, color, brightness, and/or image displayed as part of the interactable icon. Subsequently to receiving the one or more icon parameters 82 from the server computing device 80, the processor 24A may be configured to display the interactable icon based at least in part on the one or more icon parameters 82.

The one or more icon parameters 82 may also indicate the video environment navigation action 88 performed when the processor 24A detects the selection of the interactable icon. When the video environment navigation action 88 includes launching an application program 60, the video environment navigation action 88 specified in the one or more icon parameters 82 may indicate the application program 60. When the application program 60 is a web browser 60A, the video environment navigation action 88 specified in the one or more icon parameters 82 may include a web address of a webpage to which the processor 24A is configured to navigate upon launching the web browser 60A.

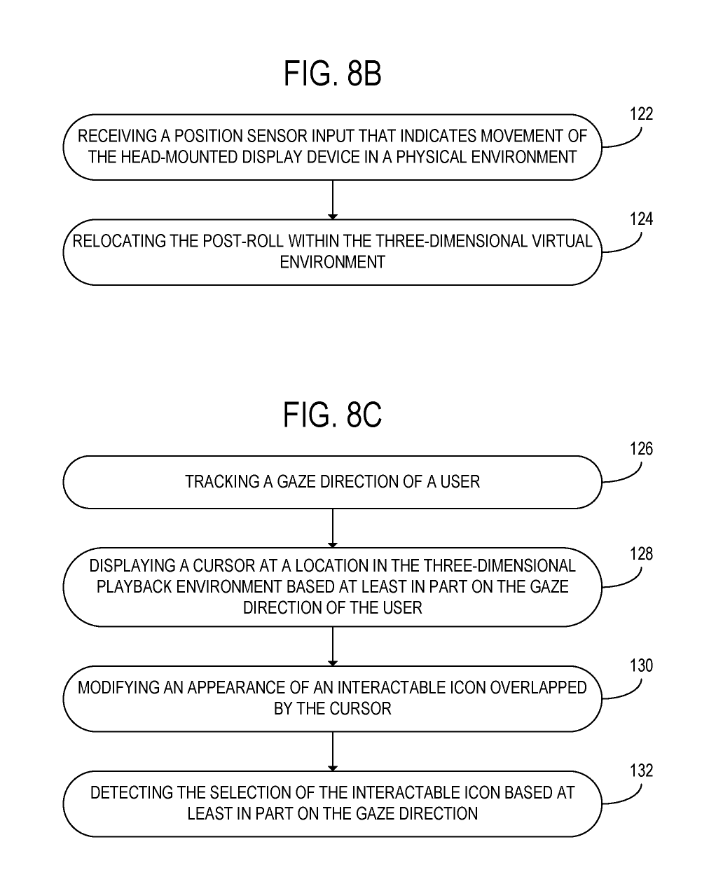

FIG. 8A is a flowchart of a method 100 for use with head-mounted display device, according to one embodiment of the present disclosure. The head-mounted display device may be the head-mounted display device 10 of FIG. 1. At step 102, the method 100 may include displaying a first 360-degree video on a display of the head-mounted display device in a three-dimensional playback environment. When the first 360-degree video ends, the method may further include, at step 104, displaying a post-roll on the display. The post-roll is displayed in the three-dimensional playback environment and includes one or more interactable icons. For example, an interactable icon may be a preview image of a second 360-degree video. Additionally or alternatively, the interactable icon may be displayed as a button.

At step 106, the method 100 may further include detecting a selection of an interactable icon of the one or more interactable icons via one or more input devices. Detecting the selection of the interactable icon may include detecting, for example, a gaze input, a gesture input, a button press or touch input on the head-mounted display device or an associated controller device, or some other form of input.

At step 108, in response to detecting the selection of the interactable icon, the method 100 may further include performing a video environment navigation action. Steps 110, 112, 114, 116, 118, and 120 are example video environment navigation actions that may be performed as part of step 108. At step 110, in embodiments in which the selected interactable icon of the one or more interactable icons is a preview image of a second 360-degree video, performing the video environment navigation action may include displaying the second 360-degree video on the display. At step 112, performing the video environment navigation action may include exiting the three-dimensional playback environment. In embodiments in which step 112 is performed, performing the video environment navigation action may further include, at step 114, displaying a three-dimensional virtual home environment or menu. At step 116, performing the video environment navigation action may include launching an application program. In some embodiments, the application program may be a web browser. In such embodiments, launching the web browser may include navigating to a webpage specified by the interactable icon. In some embodiments, if the application program indicated by the interactable icon is not installed on the head-mounted display device, performing the video environment navigation action may include launching an application store program. At step 120A, performing the video environment navigation action may include replaying the first 360-degree video, for example, when the interactable icon is a “Replay” button. At step 120B, performing the video environment navigation action may include refreshing the post-roll, for example, when the interactable icon is a “Refresh” button.

FIGS. 8B-D show additional steps that may be performed in some embodiments of the present disclosure. FIG. 8B shows steps that may be performed when the head-mounted display device includes a position sensor system. At step 122, the method 100 may further include receiving a position sensor input that indicates movement of the head-mounted display device in a physical environment. In response to receiving the position sensor input, the method may further include, at step 124, relocating the post-roll within the three-dimensional virtual environment. For example, the post-roll may be relocated to head-pose-lock the post-roll, or to scroll the post-roll in a vertical or horizontal direction in the three-dimensional playback environment.

FIG. 8C shows steps that may be performed when the head-mounted display device includes a camera configured to track a gaze direction of a user. At step 126, the method 100 may further include tracking the gaze direction of the user. At step 128, the method 100 may further include displaying a cursor at a location in the three-dimensional playback environment based at least in part on the gaze direction of the user. In some embodiments, the cursor may be displayed at a location in the three-dimensional playback environment at which the user is gazing. At step 130, the method 100 may further include modifying an appearance of an interactable icon overlapped by the cursor. For example, a size, color, brightness, or depth of the interactive icon may be modified, or another image may be displayed to represent the interactable icon. The method 100 may further include, at step 132, detecting the selection of the interactable icon based at least in part on the gaze direction. In one example, the user may select an interactable icon by gazing at the interactable icon and subsequently blinking for a duration of time exceeding a predetermined threshold.

FIG. 8D shows steps that may allow the properties of an interactable icon to be specified. At step 134, the method 100 may include receiving one or more icon parameters of the interactable icon of the one or more interactable icons from a server computing device. For example, the one or more icon parameters may include information indicating a size of the interactable icon, an appearance of the interactable icon, and a video environment navigation action that is performed when the interactable icon is selected. At step 136, the method 100 may include displaying the interactable icon based at least in part on the one or more icon parameters. Subsequently to detecting a selection of the interactable icon, the method 100 may further include, at step 138, performing the video environment navigation action based at least in part on the one or more icon parameters.

In the examples provided above, the post-roll is displayed when the 360-degree video ends. However, instead of a post-roll displayed at the end of a 360-degree video, a mid-roll may be displayed partway through the 360-degree video. For example, when playing a long video, the processor may be configured to display a mid-roll during an intermission. In such embodiments, a visual effect such as blurring may be applied to an intermediate frame rather than the last frame of the 360-degree video when the mid-roll is displayed.

Although, in the examples provided in FIGS. 2-8D, the head-mounted display device 10 is in a virtual reality configuration, embodiments in which the head-mounted display device 10 is in an augmented reality configuration are also contemplated. In such embodiments, instead of displaying a 360-degree video in a three-dimensional playback environment, one or more virtual objects may be displayed in a mixed-reality environment. The post-roll may be displayed as a virtual object in the mixed-reality environment. In some embodiments, the mixed-reality environment may include other virtual objects such as a cursor.

In some embodiments, the methods and processes described herein may be tied to a computing system of one or more computing devices. In particular, such methods and processes may be implemented as a computer-application program or service, an application-programming interface (API), a library, and/or other computer-program product.

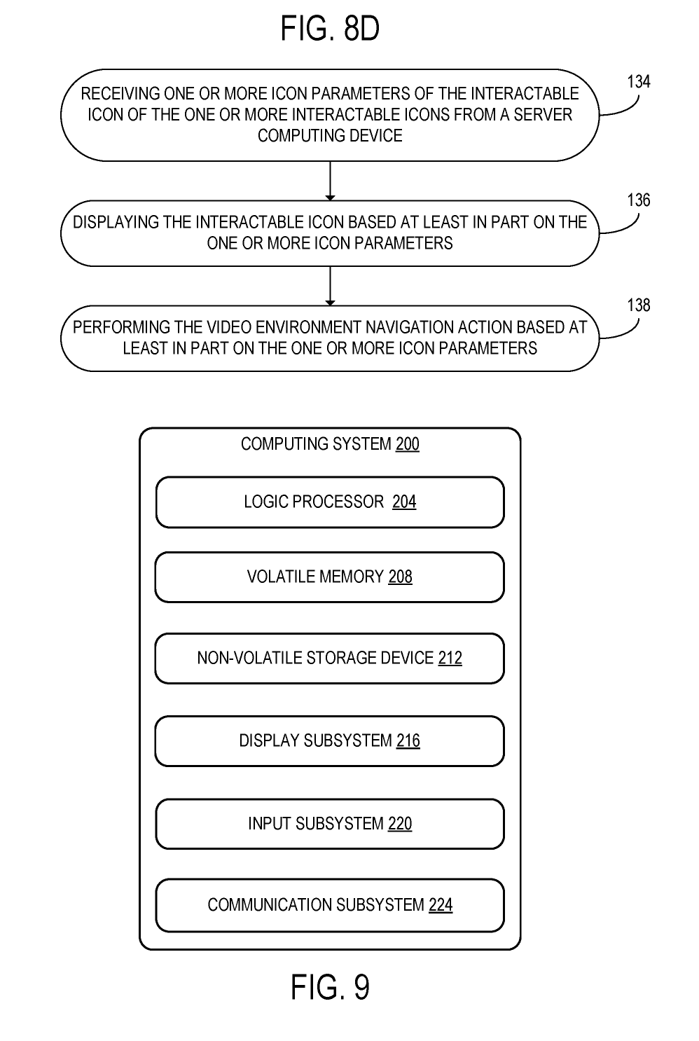

FIG. 9 schematically shows a non-limiting embodiment of a computing system 200 that can enact one or more of the methods and processes described above. Computing system 200 is shown in simplified form. Computing system 200 may embody the head-mounted display device of FIG. 1. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented/virtual reality devices.

Computing system 200 includes a logic processor 204, volatile memory 208, and a non-volatile storage device 212. Computing system 200 may optionally include a display subsystem 216, input subsystem 220, communication subsystem 224, and/or other components not shown in FIG. 9.

Logic processor 204 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 204 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects may be run on different physical logic processors of various different machines.

Volatile memory 208 may include physical devices that include random access memory. Volatile memory 208 is typically utilized by logic processor 204 to temporarily store information during processing of software instructions. It will be appreciated that volatile memory 208 typically does not continue to store instructions when power is cut to the volatile memory 208.

Non-volatile storage device 212 includes one or more physical devices configured to hold instructions executable by the logic processors to implement the methods and processes described herein. When such methods and processes are implemented, the state of non-volatile storage device 212 may be transformed—e.g., to hold different data.

Non-volatile storage device 212 may include physical devices that are removable and/or built-in. Non-volatile storage device 212 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 212 may include nonvolatile, dynamic, static, read/write, read-only, sequential-access, location-addressable, file-addressable, and/or content-addressable devices. It will be appreciated that non-volatile storage device 212 is configured to hold instructions even when power is cut to the non-volatile storage device 212.

Aspects of logic processor 204, volatile memory 208, and non-volatile storage device 212 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 200 implemented to perform a particular function. In some cases, a program may be instantiated via logic processor 204 executing instructions held by non-volatile storage device 212, using portions of volatile memory 208. It will be understood that different programs may be instantiated from the same application, service, code block, object, library, routine, API, function, etc. Likewise, the same program may be instantiated by different applications, services, code blocks, objects, routines, APIs, functions, etc. The term “program” encompasses individual or groups of executable files, data files, libraries, drivers, scripts, database records, etc.

When included, display subsystem 216 may be used to present a visual representation of data held by non-volatile storage device 212. As the herein described methods and processes change the data held by the non-volatile storage device, and thus transform the state of the non-volatile storage device, the state of display subsystem 216 may likewise be transformed to visually represent changes in the underlying data. Display subsystem 216 may include one or more display devices utilizing virtually any type of technology. Such display devices may be combined with logic processor 204, volatile memory 208, and/or non-volatile storage device 212 in a shared enclosure, or such display devices may be peripheral display devices.

When included, input subsystem 220 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection, gaze detection, and/or intent recognition; as well as electric-field sensing componentry for assessing brain activity; and/or any other suitable sensor.

When included, communication subsystem 224 may be configured to communicatively couple computing system 200 with one or more other computing devices. Communication subsystem 224 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 200 to send and/or receive messages to and/or from other devices via a network such as the Internet.

According to one aspect of the present disclosure, a head-mounted display device is provided, the head-mounted display device comprising a display, one or more input devices, and a processor. The processor may be configured to display a first 360-degree video on the display in a three-dimensional playback environment. The processor may be further configured to display a post-roll on the display when the first 360-degree video ends. The post-roll may be displayed in the three-dimensional playback environment and may include one or more interactable icons. The processor may be further configured to detect a selection of an interactable icon of the one or more interactable icons via the one or more input devices. In response to detecting the selection, the processor may be further configured to perform a video environment navigation action.

According to this aspect, the interactable icon of the one or more interactable icons may be a preview image of a second 360-degree video. The video environment navigation action may include displaying the second 360-degree video on the display.

According to this aspect, the video environment navigation action includes exiting the three-dimensional playback environment. According to this aspect, the processor may be further configured to display a three-dimensional virtual home environment subsequently to exiting the three-dimensional playback environment.

According to this aspect, the post-roll may be displayed over at least a last frame of the first 360-degree video. According to this aspect, a visual effect may be applied to the last frame of the first 360-degree video when the post-roll is displayed.

According to this aspect, the post-roll may be displayed at a fixed location within the three-dimensional playback environment.

According to this aspect, the one or more input devices may include at least one position sensor. In response to receiving a position sensor input that indicates movement of the head-mounted display device in a physical environment, the processor may be further configured to relocate the post-roll within the three-dimensional playback environment.

According to this aspect, the video environment navigation action may include launching an application program. According to this aspect, the application program may be a web browser, and launching the web browser may include navigating to a webpage specified by the interactable icon. According to this aspect, the application program may be an application store program. According to this aspect, the application program may include an option to purchase at least one of the first 360-degree video and a second 360-degree video.

According to this aspect, the video environment navigation action may include replaying the first 360-degree video.

According to this aspect, the one or more input devices may include a camera configured to track a gaze direction of a user. The selection of the interactable icon may be detected based at least in part on the gaze direction. According to this aspect, the processor may be further configured to display a cursor at a location in the three-dimensional playback environment based at least in part on the gaze direction of the user. The processor may be further configured to modify an appearance of an interactable icon overlapped by the cursor.

According to this aspect, the processor may be further configured to receive one or more icon parameters of the interactable icon of the one or more interactable icons from a server computing device. The processor may be further configured to display the interactable icon based at least in part on the one or more icon parameters. The one or more icon parameters may indicate at least one of a position and an appearance of the interactable icon. According to this aspect, the one or more icon parameters may indicate the video environment navigation action performed when the selection of the interactable icon is detected.

According to another aspect of the present disclosure, a method for use with head-mounted display device is provided, comprising displaying a first 360-degree video on a display in a three-dimensional playback environment. The method may further comprise displaying a post-roll on the display when the first 360-degree video ends. The post-roll may be displayed in the three-dimensional playback environment and may include one or more interactable icons. The method may further comprise detecting a selection of an interactable icon of the one or more interactable icons via one or more input devices. In response to detecting the selection, the method may further comprise performing a video environment navigation action.

According to this aspect, the interactable icon of the one or more interactable icons may be a preview image of a second 360-degree video. Performing the video environment navigation action may include displaying the second 360-degree video on the display.

According to another aspect of the present disclosure, a head-mounted display device is provided, the head-mounted display device comprising a display, one or more input devices, and a processor. The processor may be configured to display a first 360-degree video on the display in a three-dimensional playback environment. The processor may be further configured to display one or more interactable icons on the display in the three-dimensional playback environment. The one or more interactable icons may include at least a preview image of a second 360-degree video. The processor may be further configured to detect a selection of an interactable icon of the one or more interactable icons via the one or more input devices. In response to detecting the selection, the processor may be further configured to perform a video environment navigation action.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-mounted display device, comprising:
a display;
one or more input devices; and
a processor configured to:
display a first 360-degree video on the display in a three-dimensional playback environment;
display a post-roll on the display when the first 360-degree video ends, wherein the post-roll is displayed in the three-dimensional playback environment and includes one or more interactable icons;
detect a selection of an interactable icon of the one or more interactable icons via the one or more input devices; and
in response to detecting the selection, perform a video environment navigation action.

2. The head-mounted display device of claim 1, wherein:
the interactable icon of the one or more interactable icons is a preview image of a second 360-degree video; and
the video environment navigation action includes displaying the second 360-degree video on the display.

3. The head-mounted display device of claim 1, wherein the video environment navigation action includes exiting the three-dimensional playback environment.

4. The head-mounted display device of claim 3, wherein the processor is further configured to display a three-dimensional virtual home environment subsequently to exiting the three-dimensional playback environment.

5. The head-mounted display device of claim 1, wherein the post-roll is displayed over at least a last frame of the first 360-degree video.

6. The head-mounted display device of claim 5, wherein a visual effect is applied to the last frame of the first 360-degree video when the post-roll is displayed.

7. The head-mounted display device of claim 1, wherein the post-roll is displayed at a fixed location within the three-dimensional playback environment.

8. The head-mounted display device of claim 1, wherein:
the one or more input devices include at least one position sensor; and
in response to receiving a position sensor input that indicates movement of the head-mounted display device in a physical environment, the processor is further configured to relocate the post-roll within the three-dimensional playback environment.

9. The head-mounted display device of claim 1, wherein the video environment navigation action includes launching an application program.

10. The head-mounted display device of claim 9, wherein the application program is a web browser, and wherein launching the web browser includes navigating to a webpage specified by the interactable icon.

11. The head-mounted display device of claim 9, wherein the application program is an application store program.

12. The head-mounted display device of claim 9, wherein the application program includes an option to purchase at least one of the first 360-degree video and a second 360-degree video.

13. The head-mounted display device of claim 1, wherein the video environment navigation action includes replaying the first 360-degree video.

14. The head-mounted display device of claim 1, wherein:
the one or more input devices include a camera configured to track a gaze direction of a user; and
the selection of the interactable icon is detected based at least in part on the gaze direction.

15. The head-mounted display device of claim 14, wherein the processor is further configured to:
display a cursor at a location in the three-dimensional playback environment based at least in part on the gaze direction of the user; and
modify an appearance of an interactable icon overlapped by the cursor.

16. The head-mounted display device of claim 1, wherein the processor is further configured to:
receive one or more icon parameters of the interactable icon of the one or more interactable icons from a server computing device; and
display the interactable icon based at least in part on the one or more icon parameters, wherein the one or more icon parameters indicate at least one of a position and an appearance of the interactable icon.

17. The head-mounted display device of claim 16, wherein the one or more icon parameters indicate the video environment navigation action performed when the selection of the interactable icon is detected.

18. A method for use with head-mounted display device, comprising:
displaying a first 360-degree video on a display in a three-dimensional playback environment;
displaying a post-roll on the display when the first 360-degree video ends, wherein the post-roll is displayed in the three-dimensional playback environment and includes one or more interactable icons;
detecting a selection of an interactable icon of the one or more interactable icons via one or more input devices; and
in response to detecting the selection, performing a video environment navigation action.

19. The method of claim 18, wherein:
the interactable icon of the one or more interactable icons is a preview image of a second 360-degree video; and
performing the video environment navigation action includes displaying the second 360-degree video on the display.

20. A head-mounted display device, comprising:
a display;
one or more input devices; and
a processor configured to:
display a first 360-degree video on the display in a three-dimensional playback environment;
display one or more interactable icons on the display in the three-dimensional playback environment, wherein the one or more interactable icons include at least a preview image of a second 360-degree video;
detect a selection of an interactable icon of the one or more interactable icons via the one or more input devices; and
in response to detecting the selection, perform a video environment navigation action.
